(19) United States
(12) Patent Application Publication
(10) Pub. No.: US 2005/0011618 A1
(43) Pub. Date: Jan. 20, 2005

(54) Fabric decorative assembly and method of use thereof

(76) Inventor: Leonard Lap Tat Kee, Hillsborough, CA (US)

Correspondence Address: ANDREWS KURTH L.L.P., 1701 PENNSYLVANIA AVENUE, N.W. SUITE 300, WASHINGTON, DC, 20006, US

(21) Appl. No.: 10/685,595

(22) Filed: Oct. 16, 2003

Related U.S. Application Data
(60) Provisional application No. 60/487,159, filed on Jul. 14, 2003.

(51) Int. Cl. E06B 3/80

(52) U.S. Cl. 160/179

(57) ABSTRACT

The present invention provides a fabric assembly for interior decoration. The fabric assembly contains a base fabric having a receiving section adapted to receive a removable fabric section; one or more removable fabric sections adapted to be interchangeably attached to the receiving section; and fastening means for attaching the removable section to the receiving section of the base fabric. The removable fabric section is affixed to the base fabric to create a decorative scheme, and the decorative scheme can be easily changed by replacing the existing removable fabric section with another removable fabric section. The interchangeability between different removable fabric sections provides consumers with more decorative options without increasing the cost of decoration.

### CROSS REFERENCE TO RELATED APPLICATION(S)

This application claims the benefit of U.S. Provisional Patent Application Ser. No. 60/487,159, filed Jul. 14, 2003, the disclosure of which is hereby incorporated by reference.

### FIELD OF INVENTION

The present invention relates to fabric assemblies for interior decoration, and more particularly, to bed covers, window treatments, and similar applications with removable parts that facilitate changes in room decor.

### BACKGROUND

Typically, consumers decorate and re-decorate rooms of their houses, condominiums, or apartments multiple times. It can be very time-consuming and expensive to replace window treatments and bedding every time a consumer feels the need to re-decorate. It is also quite cumbersome to physically change bedding and re-hang window treatments.

Thus, there is a need for bed covers and window treatments that can be quickly and inexpensively replaced, adjusted, and interchanged with different styles of decoration for ease in decorating and re-decorating rooms to accommodate changes in room decor.

### SUMMARY

The present invention provides a fabric assembly for interior decoration. The fabric assembly contains a base fabric having a receiving section adapted to receive a removable fabric section; one or more removable fabric sections adapted to be interchangeably attached to the receiving section; and fastening means for attaching the removable fabric section to the receiving section of the base fabric. The removable fabric section is affixed to the base fabric to create a decorative scheme, and the decorative scheme can be easily changed by replacing one removable fabric section with another removable fabric section.

The decorative fabric assembly is used as bedcover, window treatment, or for a similar application. The incorporation of the fastening means in the fabric assembly allows easy and quick removal or replacement of part of the fabric assembly, therefore facilitates change of room decor. Moreover, the interchangeability between components of different fabric assemblies provides consumers with more decorative options without increasing the cost of decoration.

These and other advantages, aspects, and features will be understood by one of ordinary skill in the art upon reading and understanding the specification.

### BRIEF DESCRIPTION OF DRAWINGS

The invention may be described with greater clarity and particularity by reference to the accompanying drawings:

FIGS. 1A-1C depict an embodiment of the present invention, in which the fabric decorative assembly is used as a bedcover.

FIGS. 2A-2C depict another embodiment of the present invention, in which the fabric decorative assembly is used as a bedcover.

FIGS. 3A-3C depict another embodiment of the present invention, in which the fabric decorative assembly is used as a bedcover.

FIGS. 4A-4C depict another embodiment of the present invention, in which the fabric decorative assembly is used as a bedcover.

FIG. 5 depicts yet another embodiment of the present invention, in which the fabric decorative assembly is used as a window treatment.

### DETAILED DESCRIPTION

The present invention is directed to fabric decorative assemblies having removable and interchangeable parts to provide versatility and facilitate re-decoration of beds, windows, and similar applications. A base fabric assembly includes one or more sections in which a removable or interchangeable section may be fixedly attached using various fastening means. The removable sections can be interchanged to produce different decorative effects. The fabric decorative assemblies are useful for bedcover and window treatment applications, for example. As used herein, the term “bedcover” refers to any fabric assembly used to cover the surface of a bed, including but are not limited to, comforters, sheets, bedspreads, quilts, throws, coverlets, and blankets. As used herein, the term “window treatment” refers to any fabric assembly used to cover a window or part of a window, including but are not limited to, curtains, valances, and draperies. Other applications include slip covers for sofas, chairs, and day beds, decorative wall panels, area rugs, shower curtains, doorway curtains, cabinet curtains, and similar applications.

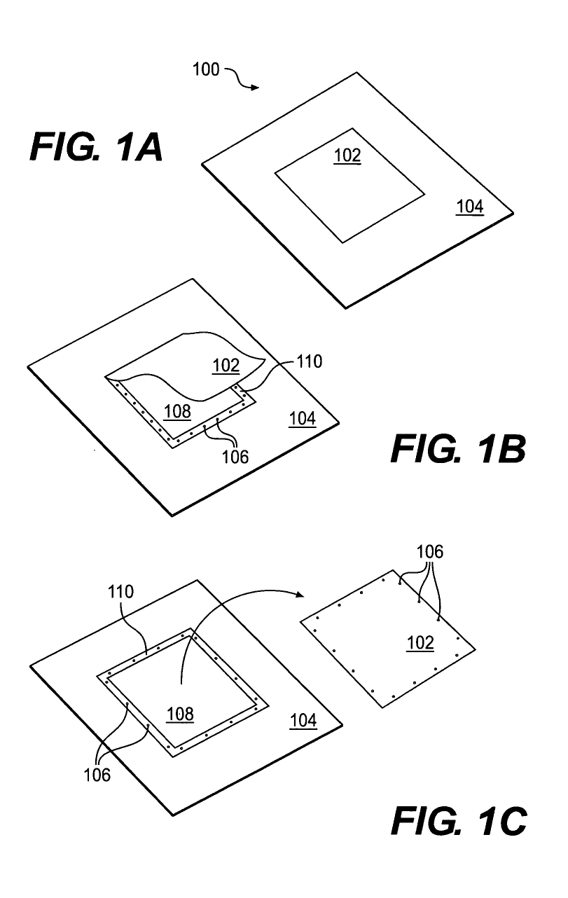

FIGS. 1A-1C show an embodiment of the fabric decorative assembly that is used as a bedcover 100. In this embodiment, the bedcover 100 contains a center panel 102 and a side panel 104 (FIG. 1A). As shown in FIG. 1B and 1C, the center panel 102 is removably attached to the side panel 104 using fasteners 106. Alternatively, the center panel 102 may be fixed and the side panels 104 may be removable.

Based on the needs of a consumer, the center panel 102 and the side panel 104 can be made of the same type of fabric or different types of fabric. The center panel 102 and the side panel 104 can have the same or different color, pattern, or style. The fasteners 106 can be any type of fastening device as is known in the art, such as buttons, snaps, ribbons, zippers, Velcro, and hooks with string. Any number of fasteners 106 can be used, as long as the center panel 102 is securely fastened to the side panels 104. Preferably, the fasteners 106 are located on a surface of the center panel 102 that is facing the side panel 104 and the fasteners 106 are not visible after the center panel 102 is secured to the side panel 104. The center panel and the side panel 104 can be made of one or more layers of fabric or synthetic fabric, or a combination thereof.

The bedcover 100 allows a consumer to quickly and conveniently redecorate a bed by replacing the center panel 102 or the side panel 104 with a substitute panel of a different color, reflection, pattern, or style. The interchangeability also allows the consumer to create new decorative styles by making new center/side panel combinations from existing bedcovers 100, therefore saving the expense of purchasing another bedcover 100. The center panel 102 and side panels 104, as well as the assembled bedcover 100, can be of varying sizes, depending on the size of the bed and the consumer's needs. The area covered by the center panel 102, designated area 108, can be a continuous part of the side panel 104. Alternatively, area 108 can be an open space on the side panel 104 and the center panel 102 is attached to the side panel 104 through fasteners 106 located along borders 110 of the area 108.

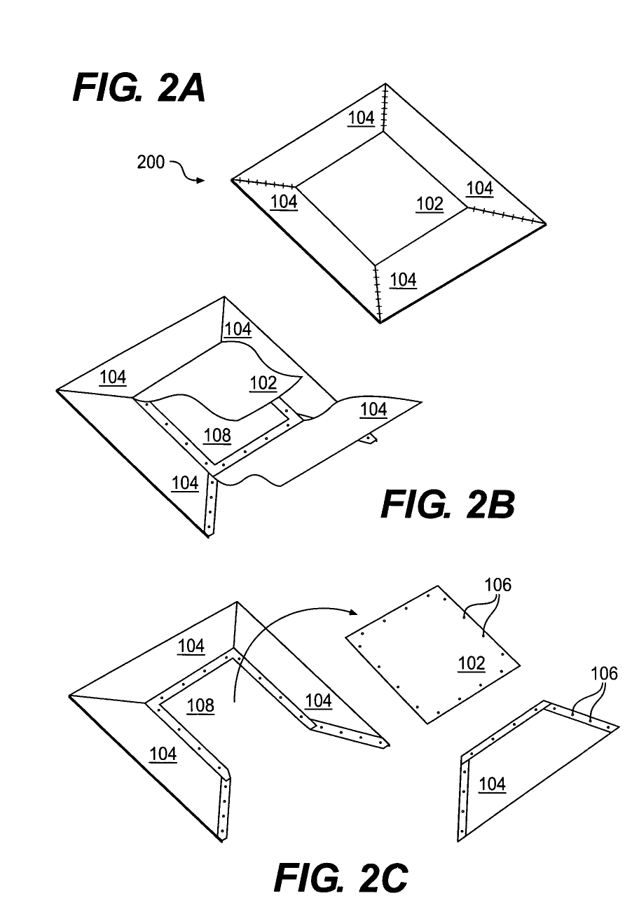

FIGS. 2A-2C depict another embodiment of the fabric decorative assembly, generally designated as bedcover 200. In this embodiment, there are one center panel 102 and multiple side panels 104. The side panels 104 are attached to each other through fasteners 106 at the edges of each side panel 104. The side panels 104 can also be attached to the center panel 102 in various combinations desired by a consumer. For example, a consumer may decide to attach one, two, three, or four side panels 104 to the center panel 102 to fit beds of different sizes or decorate the same bed in different styles. This embodiment thus provides more flexibility and interchangeability in the use of the bedcover 200 which, when combined with other bedcovers 200, would allow an even larger number of possible combinations and vastly expanded decorative choices.

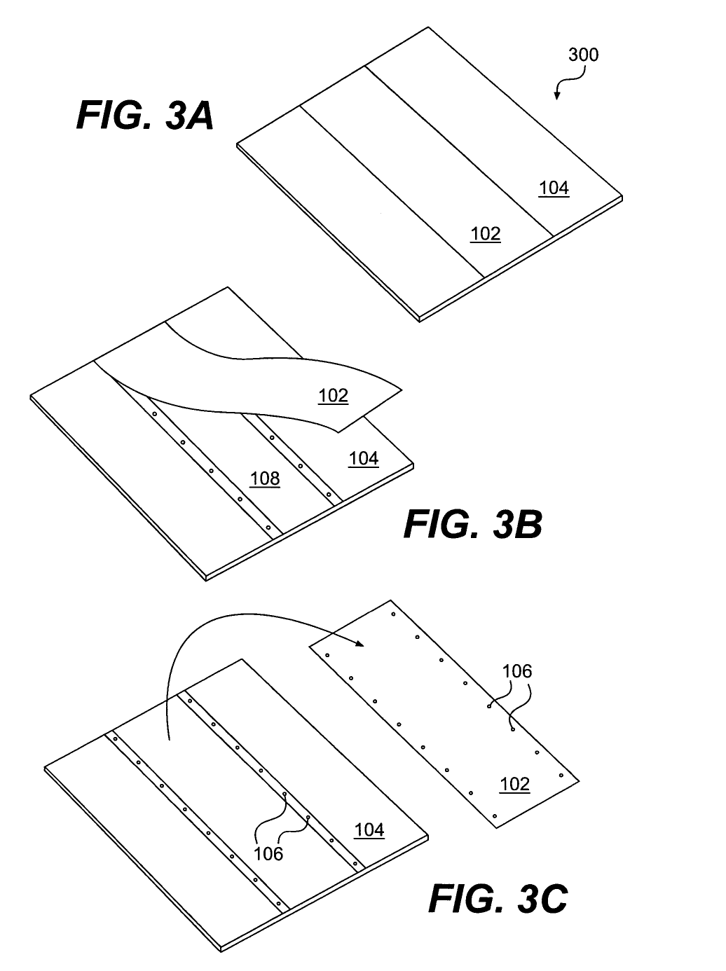

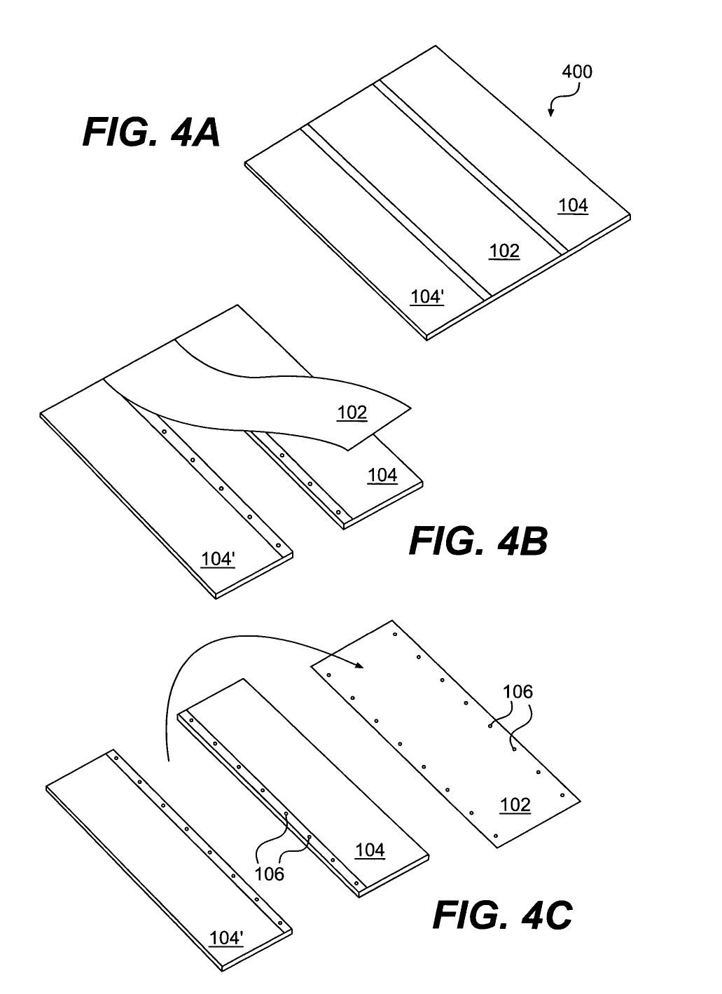

FIGS. 3A-3C depict yet another embodiment of the fabric decorative assembly as bedcover 300. In this embodiment, the center panel 102 has a length that is the same as the length of the side panel 104 and a width that is smaller than the width of the side panel 104. Preferably, the center panel 102 is removably attached to the side panel 104 through fasteners 106 that are not visible after attachment. In this embodiment, the side panel 104 is a single piece of fabric and the center panel 102 covers the center portion 108 of the side panel 104. Alternatively, there can be two side panels 104 and 104′, each attached to one side of the center panel 102 through fasteners 106, as shown in FIGS. 4A-4C.

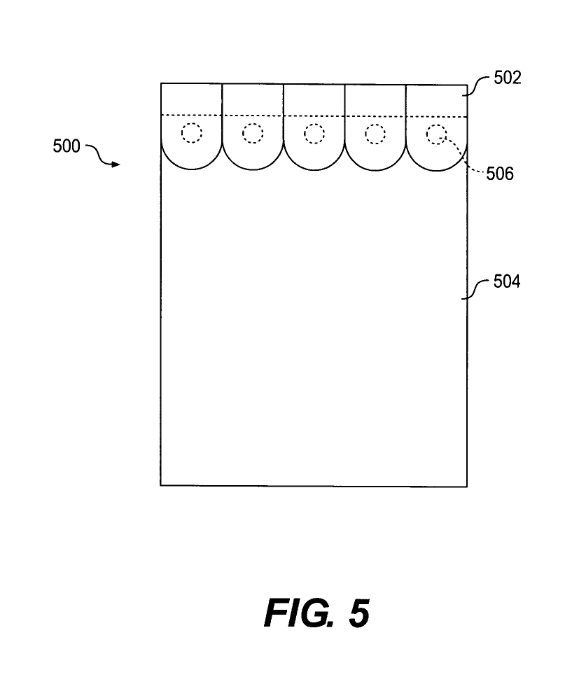

FIG. 5 shows another embodiment of the fabric decorative assembly as a window treatment 500. The window treatment 500 contains a top panel 502 and a lower panel 504. The top panel 502 is preferably attached to a rail or board or any kind of support above a window. The lower panel 504 is removably attached to the top panel 502 using fasteners 506. Based on the needs of a consumer, the top panel 502 and the lower panel 504 can be made of the same type of fabric or different types of fabric. The top panel 502 and the lower panel 504 can also have the same or different color, pattern, or style. The fasteners 506 can be any type of fastening device known in the art, such as buttons, snaps, ribbons, zippers, Velcro, and hooks with string. Any number of fasteners 506 can be used, as long as the lower panel 504 is securely fastened to the top panel 502. The fasteners 506 allow the lower panel 504 to be detached from and reattached to the top panel 502, so that lower panels of various color, size, and style can be interchanged easily and quickly, depending on the consumers' needs.

In other embodiments, the fabric decorative assembly can be used to decorate beds in the form of comforters, sheets, bedspreads, quilts, throws, coverlets, blankets, and windows in the form of curtains, valances, draperies, and the like. The fabric decorative assembly can also be used as slip covers for sofas, chairs, and day beds, decorative wall panels, area rugs, shower curtains, doorway curtains, cabinet curtains, and other similar applications. The removable and interchangeable feature of the fabric decorative assembly allows easy and quick rearrangement of panels of different sizes, colors, and styles and, therefore, facilitates changes in room decor.

The fabric decorative assembly may be packaged as a kit that includes the base fabric and one or more interchangeable, removable fabric sections. Additional interchangeable, removable fabric sections may be acquired to supplement the fabric decorative assembly kit. Thus, a consumer may purchase the fabric decorative assembly kit. When the consumer decides to change decor, but is no longer satisfied with the decorative choices in the kit, the consumer may purchase additional interchangeable, removable fabric sections that suit the consumer's current decorating ideas.

Although the preferred embodiment has been described in detail, it should be understood that various changes, substitutions, and alterations can be made therein without departing from the scope of the invention. It will be appreciated that various changes in the details, materials and arrangements of parts, which have been herein described and illustrated in order to explain the nature of the invention, may be made by those skilled in the area within the principle and scope of the invention.

1. An decorative fabric assembly, comprising:
a base fabric comprising a receiving section adapted to receive a removable fabric section;
one or more removable fabric sections adapted to be interchangeably attached to the receiving section; and
fastening means for attaching the one or more removable sections to the receiving section of the base fabric, wherein a first removable fabric section is affixed to the base fabric to create a first decorative scheme, and wherein the first removable fabric section is capable of removal and replacement with a second removable fabric section to create a second decorative scheme.

2. The decorative fabric assembly of claim 1, wherein the fastening means is selected from the group consisting of buttons, snaps, ribbons, zippers, Velcro, and hooks with strings.

3. The decorative fabric assembly of claim 1, wherein the fastening means is not visible after the removable fabric section is attached to the base fabric member.

4. The decorative fabric assembly of claim 1, wherein the receiving section is located at the center of the base fabric.

5. The decorative fabric assembly of claim 1, wherein the base fabric is attached to one of the removable fabric sections to form a bed cover.

6. The decorative fabric assembly of claim 1, wherein the base fabric comprises additional receiving sections adapted to receive the removable fabric sections.

7. The decorative fabric assembly of claim 6, wherein the base fabric is attached to multiple removable fabric sections to form a bed cover.

8. The decorative fabric assembly of claim 1, wherein each fastening means comprises a first component located on the base fabric and a second component located on the removable fabric section, and wherein the first component is capable of attaching to the second component to secure removable fabric section to the base fabric.

9. The decorative fabric assembly of claim 1, wherein the base fabric comprises a top panel, and wherein the removable fabric section is interchangeably attached to the base fabric by the fastening means to form a window treatment.

10. The decorative fabric assembly of claim 9, wherein the base fabric further comprises means for attachment to a rail or any other solid support above a window.

11. The decorative fabric assembly of claim 1, wherein the base fabric comprises multiple pieces of sub-base fabric, said multiple pieces of sub-base fabric removably and interchangeably attached to each other by fastening means to form the base fabric.

12. A decorative fabric assembly for covering a bed, comprising:
a base fabric sheet comprising a receiving section adapted to receive a removable fabric section;
one or more removable fabric sections adapted to be interchangeably attached to the receiving section; and
fasteners for attaching the one or more removable sections to the receiving section of the base fabric, wherein a first removable fabric section is affixed to the base fabric to create a first decorative scheme, and wherein the first removable fabric section is capable of removal and replacement with a second removable fabric section to create a second decorative scheme.

13. The decorative fabric assembly of claim 12, wherein the receiving section is located at the center of the base fabric.

14. The decorative fabric assembly of claim 12, wherein the fasteners are selected from the group consisting of buttons, snaps, ribbons, zippers, Velcro, and hooks with strings.

15. The decorative fabric assembly of claim 12, wherein the fasteners are invisible after the removable fabric section is attached to the base fabric.

16. The decorative fabric assembly of claim 12, wherein the base fabric comprises additional receiving sections adapted to receive the removable fabric sections.

17. A decorative fabric assembly for covering a window, comprising:
a top fabric panel;
one or more removable fabric sections adapted to be interchangeably attached to the top fabric panel; and
fasteners for attaching the one or more removable fabric sections to the top fabric panel, wherein a first removable fabric section is affixed to the top fabric panel to create a first decorative scheme, and wherein the first removable fabric section is capable of removal and replacement with a second removable fabric section to create a second decorative scheme.

18. The decorative fabric assembly of claim 17, wherein the top fabric panel comprises means to attach to a solid supporting structure above a window.

19. The decorative fabric assembly of claim 17, wherein the top fabric panel is a fabric with ruffles.

20. The decorative fabric assembly of claim 17, wherein the decorative fabric is a valance.

21. A method for room decoration, comprising:
covering an item or an opening with a fabric assembly comprising a base fabric including a receiving section adapted to receive a removable fabric section to create a first decorative scheme, and a removable fabric section adapted to be interchangeably attached to the receiving section using fastening means.

22. The method of claim 21, further comprising:
removing the removable fabric section from the fabric assembly; and
replacing the removed removable fabric section with another removable fabric section to create a second decorative scheme.

23. The method of claim 21, further comprising:
attaching the base fabric to a solid supporting structure.

24. A fabric decorating kit, comprising:
a base fabric comprising a receiving section adapted to receive a removable fabric section;
one or more removable fabric sections adapted to be interchangeably attached to the receiving section; and
fastening means for interchangeably attaching the one or more removable fabric sections to the receiving section of the base fabric, therefore creating one or more decorative schemes.

25. A fabric window treatment kit, comprising:
a top fabric panel;
one or more removable fabric sections adapted to be interchangeably attached to the top fabric panel; and fasteners for interchangeably attaching the one or more removable fabric sections to the top fabric panel, therefore creating one or more decorative schemes.
